(19) United States
(12) Patent Application Publication
(10) Pub. No.: US 2002/0126481 A1
(43) Pub. Date: Sep. 12, 2002

(54) Positioning structure of a hanging light bulb string

(76) Inventor: Wun Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/803,097

(22) Filed: Mar. 12, 2001

(51) Int. Cl. F21V 21/00

(52) U.S. Cl. 362/249; 362/252

(57) ABSTRACT

The present invention relates to a positioning structure of a hanging light bulb string, which mainly provides several positioning rods with several connectors between the arched string to receive the arched string in related separated position. It can keeps the hanging light bulb string in a perfect decorative display and it can prevent the arched string from being winded with each other for providing a better lighting effect.

### BACKGROUND OF THE INVENTION

A known hanging light bulb string is usually including a long bulb string or several parallel short bulb strings being connected to become a curved-type hanging string. Each arched string is hanging naturally and may be winded with each other possibly in use. So the main decorative purpose can not be maintained and the lighting effect is also lost.

Accordingly, the primary object of the invention is to provide a positioning structure of a hanging light bulb string, which provides several positioning rod to keep the arched string in a related place and to maintain a perfect decorative curved-type hanging string. Now the features and advantages of the present invention will be described in detail with reference to the accompanying drawings.

### BRIEF DESCRIPTION OF ACCOMPANYING DRAWINGS

FIG. 1 is a plan exemplary view showing a hanging light bulb string according to the present invention.

FIG. 2 is a perspective view of a positioning rod according to the present invention.

FIG. 3 is a plan view of FIG. 1 connected with a controller according to the present invention.

### DETAILED DESCRIPTION OF PREFERRED EMBODIMENTS

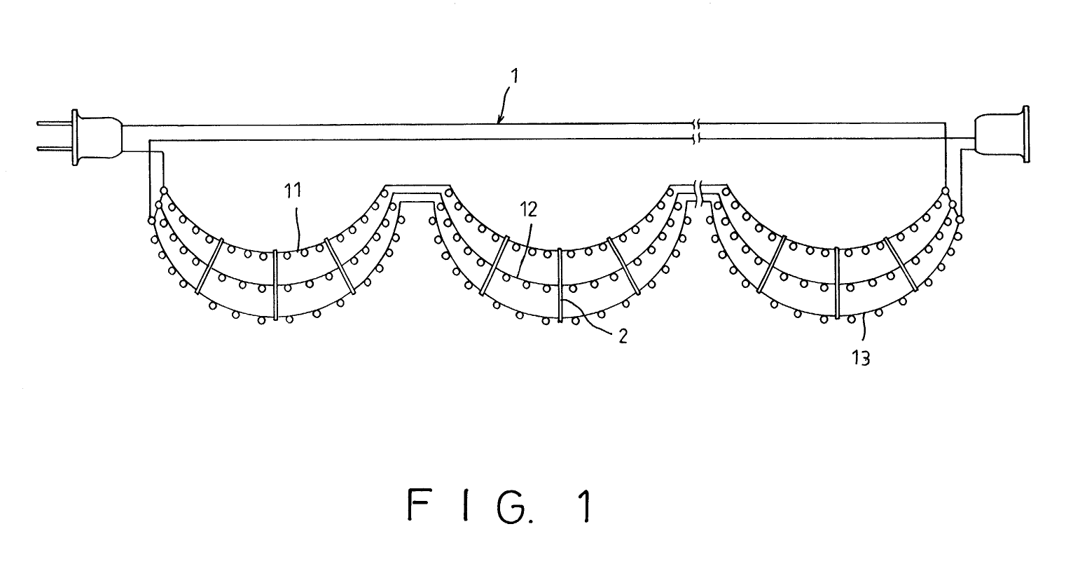

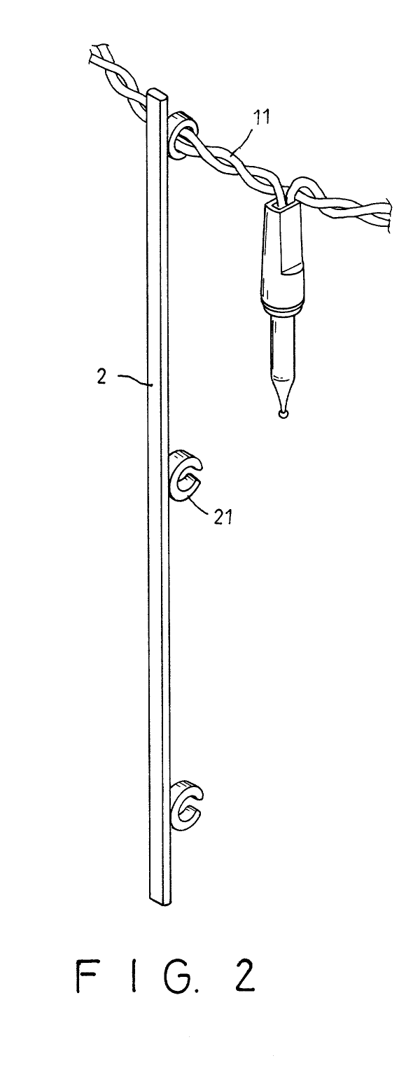

Referring to FIGS. 1 and 2, the present invention is disclosed with three arched strings for example. It can be seen that the invention includes a main electrical wire (1) with a first arched string (11), a second arched string (12), and a third arched string (13) being connected in parallel. It is the most characteristic that several rods (2) are provided between the arched strings. The rod (2) is provided with three connectors (21) at intervals for receiving the related arched strings therein to obtain the positioning effect. Since each arched string will be actually positioned by the positioning rod (2), it will never be winded with each other for overcoming the drawback of a prior one.

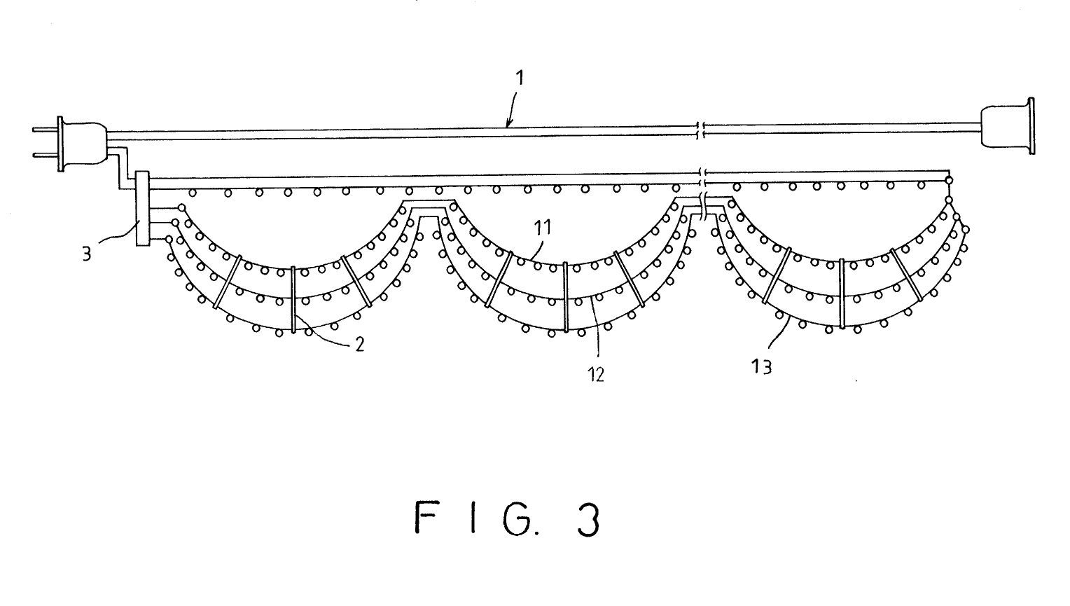

As above mentioned, it is only an exemplary according to the present invention. It can provide with a controller (3) connecting with the parallel branch strings for controlling and varying the lighting effect, as shown in FIG. 3. Moreover, other simple modification will be claimed in this invention, such as to increase the number of the arched string and the length of the positioning rod with increasing connector for shining purpose.

What is claimed is:

1. A positioning structure of a hanging light bulb string including a main electrical wire with a long bulb string or several parallel bulb string being connected to become a continuous curved-type string having a plurality of arched strings; the characteristic is that several positioning rods provided with several connectors being provided between the arched strings and each arched string being received within the related connectors of the rod in position to maintain a original form and to prevent from being winded with each other.

2. The positioning structure of a hanging light bulb string as claimed in claim 1, wherein the number of the arched string is more than two.

3. The positioning structure of a hanging light bulb string as claimed in claim 1, wherein a controller is provided to connect with the parallel arched strings.
